(19) United States
(12) Patent Application Publication
(10) Pub. No.: US 2017/0198749 A1
(43) Pub. Date: Jul. 13, 2017

(54) BEARING APPARATUS FOR WHEELS

(71) Applicant: JTEKT CORPORATION, Osaka (JP)

(72) Inventor: Nobuyuki SEO, Toyoake-shi (JP)

(73) Assignee: JTEKT CORPORATION, Osaka (JP)

(21) Appl. No.: 15/392,661

(22) Filed: Dec. 28, 2016

(30) Foreign Application Priority Data
Jan. 13, 2016 (JP) 2016-004233

(51) Int. Cl. F16C 19/18; B60B 27/06; F16C 33/80; B60B 27/00

(52) U.S. Cl. CPC F16C 19/181; B60B 27/0005; B60B 27/0073; B60B 27/065; B60B 27/0094; F16C 33/80; F16C 2326/02

(57) ABSTRACT

A bearing apparatus for wheels includes an outer ring, a hub shaft having a flange portion for Wheel attachment on a vehicle outer side, rolling elements provided between the outer ring and the hub shaft, a seal attached to the vehicle-outer-side part of the outer ring, and a slinger that is attached to the vehicle-outer-side part of the hub shaft and contacted by the seal An outer peripheral surface of the outer ring has a non-plated surface portion provided at a vehicle-outer-side end and a plated surface portion continuous with the non-plated surface portion. The slinger has a slinger main body portion that is contacted by the seal and a cylindrical facing portion that faces the non-plated surface portion to form a labyrinth clearance.

### INCORPORATION BY REFERENCE

The disclosure of Japanese Patent Application No. 2016-004233 filed on Jan. 13, 2016 including the specification, drawings and abstract, is incorporated herein by reference in its entirety.

### BACKGROUND OF THE INVENTION

1. Field of the Invention

The invention relates to a bearing apparatus for wheels.

2. Description of the Related Art

In vehicles such as automobiles, a bearing apparatus for wheels (hub unit) is used to support wheels so as to make the wheels rotatable. The bearing apparatus for wheels includes an outer ring, a hub shaft, and rolling elements. The outer ring is fixed to a suspension on a vehicle body side. The wheels are attached to the hub shaft. The rolling elements are provided between the outer ring and the hub shaft. In such a bearing apparatus for wheels, in order to restrain foreign matter such as water from entering, from a vehicle outer side, a bearing interior where the rolling elements are provided, a seal is attached to the vehicle-outer-side part of the outer ring. A slinger that is contacted by the seal is attached to the vehicle-outer-side part of the hub shaft.

In order to enhance sealing performance on the vehicle outer side using the seal and the slinger as described above, a bearing apparatus for wheels has been proposed in which, besides the seal, a deflector is provided on an outer periphery of a vehicle-outer-side end of the outer ring as disclosed in, for example, Japanese Patent Application Publication No. 2012-56412 (JP 2012-56412 A).

In the bearing apparatus for wheels described in JP 2012-56412 A, a labyrinth clearance is formed between the deflector and the slinger to allow foreign matter such as water to be made less likely to enter through a contact portion between the seal and the slinger, enabling enhancement of the sealing performance on the vehicle outer side.

However, in the bearing apparatus for wheels described in JP 2012-56412 A, the new member (deflector) needs to be added to the outer ring. This results in an increase in component cost and in man-hour needed for attachment.

### SUMMARY OF THE INVENTION

An object of the invention is to provide a bearing apparatus for wheels that makes external foreign matter such as water less likely to enter a bearing interior without the use of an additional member.

A bearing apparatus for wheels in an aspect of the invention includes an outer ring fixed to a vehicle-body-side member, a hub shaft provided inward of the outer ring in a radial direction and having a flange portion for wheel attachment on a vehicle outer side, rolling elements provided between the outer ring and the hub shaft, a seal attached to the vehicle-outer-side part of the outer ring, and a slinger that is attached to the vehicle-outer-side part of the hub shaft and contacted by the seal. An outer peripheral surface of the outer ring has a non-plated surface portion provided at a vehicle-outer-side end and a plated surface portion continuous with the non-plated surface portion. The slinger has a slinger main body portion that is contacted by the seal and a cylindrical facing portion that faces the non-plated surface portion to form a labyrinth clearance.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a sectional view depicting an embodiment of a bearing apparatus for wheels in the invention;

FIG. 2 is an enlarged sectional view depicting a configuration of a vehicle-outer-side end of an outer ring, a sealing apparatus, and a periphery of the sealing apparatus; and

FIG. 3 is a sectional view depicting a variation of a facing portion of a slinger.

### DETAILED DESCRIPTION OF EMBODIMENTS

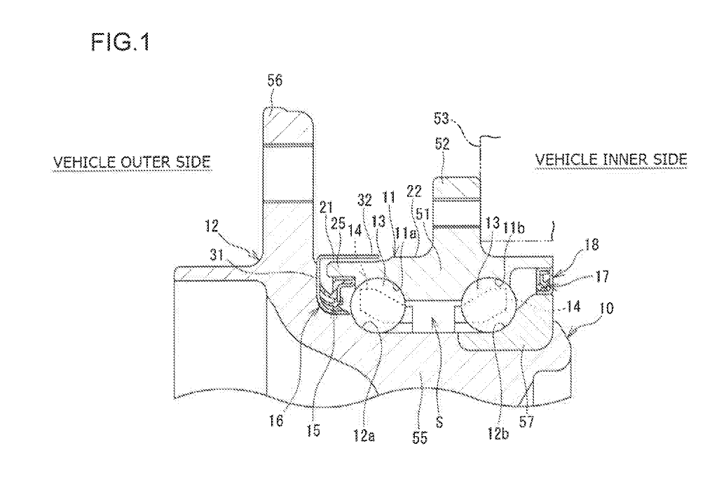

An embodiment of the invention will be described below based on the drawings. FIG. 1 is a sectional view depicting an embodiment of a bearing apparatus for wheels in the invention. A bearing apparatus for wheels (hub unit) 10 is, for example, attached to a suspension on a vehicle body side of an automobile to support wheels so as to make the wheels rotatable. The bearing apparatus for wheels 10 includes an outer ring 11, a hub shaft 12, rolling elements 13, a cage 14, seals 15, 17, and slingers 16, 18.

The outer ring 11 is a cylindrical member formed of, for example, high-carbon steel. The outer ring 11 has a cylindrical outer ring main body 51 and a flange portion 52 for fixation. The flange portion 52 extends outward from the outer ring main body 51 in a radial direction. The flange portion 52 is fixed to a knuckle 53 that is a vehicle-body-side member. Consequently, the bearing apparatus for wheels 10 including the outer ring 11 is fixed to the knuckle 53. With the bearing apparatus for wheels 10 fixed to the vehicle body side, the side on which a flange portion 56 described below is provided for wheel attachment on the hub shaft 12 corresponds to a vehicle outer side. In other words, a left side in FIG. 1 (flange portion 56 side) corresponds to a vehicle outer side, and a right side in FIG. 1 corresponds to a vehicle inner side. A lateral direction in FIG. 1 corresponds to an axial direction of the bearing apparatus for wheels 10. On an inner peripheral surface of the outer ring 11, a vehicle-outer-side outer-ring raceway surface 11a and a vehicle-inner-side outer-ring raceway surface 11b are formed.

The hub shaft 12 has a shaft main body portion 55, the flange portion 56 for wheel attachment, and an inner ring member 57. The shaft main body portion 55, the flange portion 56, and the inner ring member 57 are formed of, for example, high-carbon steel. The shaft main body portion 55 is a shaft member that is elongate in the axial direction. The flange portion 56 extends outward in the radial direction from the vehicle-outer-side part of the shaft main body portion 55. The inner ring member 57 is an annular member that is fixedly fitted on the vehicle-inner-side part of the shaft main body portion 55. A wheel and a brake rotor not depicted in the drawings are attached to the flange portion 56. A shaft raceway surface 12a is formed on a vehicle-outer-side outer peripheral surface of the shaft main body portion 55. An inner-ring raceway surface 12b is formed on an outer peripheral surface of the inner ring member 57.

The vehicle-outer-side outer-ring raceway surface 11a and the shaft raceway surface 12a face each other in the radial direction. The vehicle-inner-side outer-ring raceway surface 11b and the inner-ring raceway surface 12b face each other in the radial direction. Balls that are rolling elements 13 are arranged between the vehicle-outer-side raceway surfaces and the vehicle-inner-side raceway surfaces. Two rows of the rolling elements (balls) 13 are provided. The rolling elements (balls) 13 in each row are held by an annular cage 14. The rolling elements 13 are provided between the outer ring 11 and the hub shaft. 12. Consequently, the hub shaft 12 is concentrically arranged inward of the outer ring 11 in the radial direction. An annular space S is formed between the outer ring 11 and the hub shaft 12. An area in the annular space S where the two rows of the rolling elements 13 are arranged corresponds to a bearing interior.

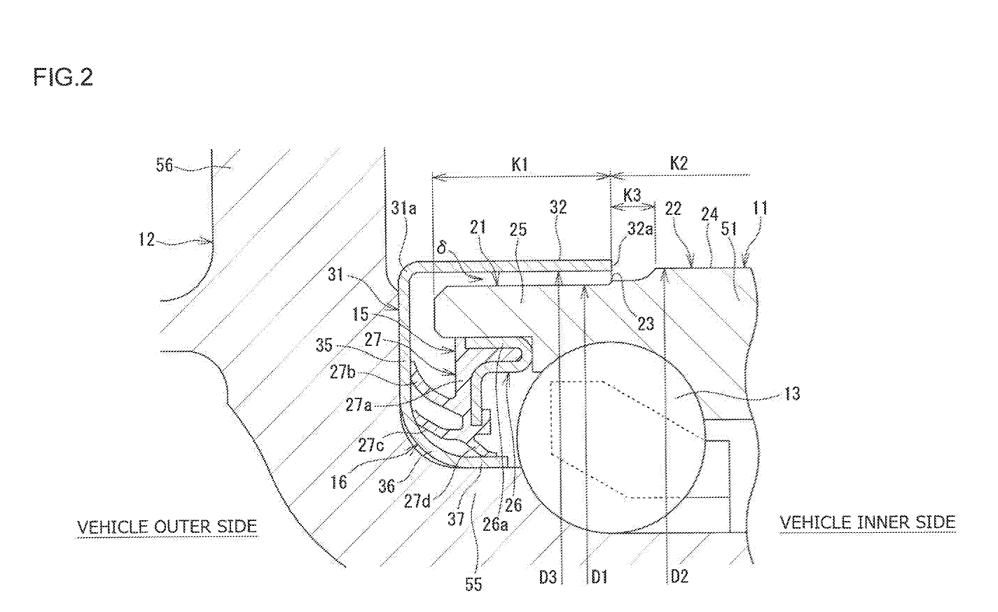

The outer ring 11 is entirely plated. However, an inner peripheral surface of the outer ring 11, including the outer-ring raceway surfaces 11a, 11b, is ground, and therefore, plating is removed from the inner peripheral surface, which is thus a machined surface (ground surface) with the base material of the outer ring 11 exposed. A part of an outer peripheral surface of the outer ring 11 is also ground, and therefore, plating is removed from this part, which is thus a machined surface (ground surface) with the base material of the outer ring 11 exposed therefrom. As depicted in FIG. 2, an area K1 at a vehicle-outer-side end 25 is the area of the outer peripheral surface of the outer ring 11 from which the plating is removed. The area K1 corresponds to a non-plated surface portion 21.

The area K1 from which plating has been removed (non-plated surface portion 21) is a machined surface (ground surface) and forms a machining reference surface for grinding of the inner peripheral surface of the outer ring 11. In other words, the machining reference surface is provided on an outer peripheral surface of the end 25 of the outer ring 11. Although not depicted in the drawings, a shoe (patch) is brought into contact with the machining reference surface during the production of the outer ring 11 so as to receive a machining three (pressing force) exerted on the outer ring 11 by a grinding wheel. The machining reference surface (non-plated surface portion 21) is ground and is thus an accurately formed cylindrical surface. In other words, the non-plated surface portion 21, which is a cylindrical surface, is smooth and has a high roundness and a constant outside diameter D1. A center line of the non-plated surface portion 21, which is a cylindrical surface, corresponds to a center line of the outer ring 11. The center line is the same as a center line of the bearing apparatus for wheels 10.

A plated layer is provided in an area K2, that is, the entire outer peripheral surface of the outer ring 11 except for the area K1. Thus, the area K1 corresponds to the non-plated surface portion 21, and the area K2 corresponds to a plated surface portion 22. The outer peripheral surface of the outer ring 11 has the non-plated surface portion 21, provided at the vehicle-outer-side end 25 and the plated surface portion 22, which is continuous with the non-plated surface portion 21.

The hub shaft 12 is also entirely plated. However, an outer peripheral surface of the hub shaft 12, including the shaft raceway surface 12a and the inner-ring raceway surface 12b, is also ground. Consequently, plating has been removed from a certain area of the hub shaft 12.

As depicted in FIG. 1, a sealing apparatus including the seal 15 and the slinger 16 is provided on the vehicle outer side. A sealing apparatus including the seal 17 and the slinger 18 is provided on the vehicle inner side. In each of the sealing apparatuses, the seal 15 (17) contacts the slinger 16 (18) to enable prevention of foreign matter from a hearing exterior such as water (muddy water) from entering a bearing interior and prevention of a lubricant (grease) provided in the bearing interior from leaking to the bearing exterior.

The seal 15 and the slinger 16 on the vehicle outer side will further be described. In FIG. 2, the seal 15 is attached to an inner periphery of the vehicle-outer-side end 25 of the outer ring 11. The slinger 16 is attached to the vehicle-outer-side part of the hub shaft 12 so as to be contacted by a part of the seal 15.

The seal 15 has metal core 26 and a rubber se& main body 27. The seal main body 27 has a fixed portion 27a, and a plurality of lips 27b, 27c, 27d. The fixed portion 27a is fixed (vulcanized and bonded) to the core 26. The lips 27b, 27c, 27d protrude from the fixed portion 27a. The core 26 has a cylindrical portion 26a as an outer peripheral portion thereof The cylindrical portion 26a is fitted to an inner peripheral surface of the end 25 of the outer ring 11 in close contact with the inner peripheral surface. Consequently, the seal 15 is fixed to the outer ring 11.

The slinger 16 is attached to an outer periphery of a boundary portion between the shaft main body portion 55 of the hub shaft 12 and the flange portion 56, The slinger 16 has a slinger main body portion 31 and a cylindrical facing portion 32. The slinger main body portion 31 is contacted by the lips 27b, 27c, 27d of the seal 15. The facing portion 32 extends in the axial direction from an outer peripheral end 31a of the slinger main body portion 31. The cylindrical facing portion 32 faces the non-plated surface portion 21 of the outer ring 11 in the radial direction. An outside diameter D1 of the non-plated surface portion 21 is slightly smaller than a bore diameter D3 of the facing portion 32 (D1<D3). Consequently, a labyrinth clearance δ is formed between the non-plated surface portion 21 and the facing portion 32.

The slinger main body portion 31 has a circular ring portion 35, a curved surface portion 36, and a short cylinder portion 37 arranged in this order from the facing portion 32 side. The short cylinder portion 37 is externally fitted over the shaft main body portion 55, and the circular ring portion 35 is in contact with a side surface of the flange portion 56. The cylindrical facing portion 32 extends in the axial direction from the outer peripheral end (31a) of the circular ring portion 35.

The cylindrical facing portion 32 is shaped like a cylinder centered around the center line of the bearing apparatus for wheels 10. The facing portion 32 has a larger axial length than the non-plated surface portion 21 (area K1). In the present embodiment, a vehicle-inner-side end 32a of the facing portion 32 is positioned outward of the boundary 23 between the non-plated surface portion 21 and the plated surface portion 22 in the radial direction. The facing portion 32 externally covers the entire non-plated surface portion 21 in the radial direction. The length of the facing portion 32 may be slightly smaller than the length depicted in FIG. 2. However, the facing portion 32 is preferably long so as to increase the length of the labyrinth clearance δ to more effectively suppress entrance of foreign matter.

As described above, the outer peripheral surface of the outer ring 11 is plated so that a plated layer is formed. However, the end 25 is turned and the resultant turned surface is ground. The grinding allows the base material of the outer ring 11 to be exposed to form the non-plated surface portion 21. In FIG. 2, the area of the turned. surface is denoted by K3. The end 25 of the outer ring 11 has a stepped shape in which the outside diameter of the end 25 decreases in a stepwise fashion toward the vehicle outer side. An outer peripheral surface of the outer ring main body 51 has a linear cylindrical surface 24 located on the vehicle inner side with respect to the area K3 of the turned surface and centered around the center line of the outer ring 11. The cylindrical surface 24 is included in the plated surface portion 22. In the present embodiment, plating remains in the area K3 of the turned surface, which is thus included in the plated surface portion 22.

The non-plated surface portion 21 is ground as described above and is thus dimensionally accurate. The slinger 16 is formed to have a sectional shape depicted in FIG. 2 by pressing a circular-ring-shaped plate member. The use of pressing using a mold allows the portions of the slinger 16 to be accurately formed. In particular, an inner peripheral surface of the facing portion 32 is smooth and has a high roundness and a constant bore diameter D3. Thus, a slight clearance (labyrinth clearance δ) is easily formed between the non-plated surface portion 21 and the facing portion 32 of the slinger 16. In the present embodiment, the bore diameter D3 of the facing portion 32 is set smaller than the outside diameter D2 of the cylindrical surface 24 (D3<D2). The non-plated surface portion 21 is machined to accurately have the outside diameter D1 to reduce the clearance (labyrinth clearance δ) between the facing portion 32 and the non-plated surface portion 21. A relationship D1<D3<D2 is present among the outside diameter D1 of the non-plated surface portion 21, the bore diameter D3 of the facing portion 32, and the outside diameter D2 of the cylindrical surface 24 of the outer ring 11.

The bearing apparatus for wheels 10 configured as described above enables a rust prevention function to be enhanced by the plated surface portion 22. On the vehicle outer side, the labyrinth clearance δ is formed between the non-plated surface portion 21 of the outer peripheral surface of the outer ring 11 and the facing portion 32 of the slinger 16. Thus, external foreign matter such as water can be made less likely to enter through the contact portion between the seal 15 and the slinger 16 without the use of an additional member as in the conventional art.

In particular, in the present embodiment, the non-plated surface portion 21 is a machined surface serving as a reference for machining the outer ring 11. Thus, the non-plated surface portion 21 is more accurately formed, enabling the labyrinth clearance δ to be set small. This allows further enhancement of the function to make foreign matter such as water less likely to enter. Furthermore, instead of additionally machining the non-plated surface portion 21, the present embodiment utilizes the machined surface serving as a reference for grinding of the outer ring 11, as a surface allowing the labyrinth clearance δ to be formed. This enables an increase in machining cost (machining man-hour) to be prevented.

To form a labyrinth clearance between the outer ring 11 and the hub shaft 12 on the vehicle outer side and further to reduce the clearance in size so as to deliver high labyrinth performance, the related art needs to use an accurately formed additional member or to accurately finish a member (surface) for forming the labyrinth clearance. However, the present embodiment uses, as a surface for forming the labyrinth clearance δ, the machining reference surface (machined surface) needed for grinding of the outer-ring raceway surfaces 11a, 11b. This eliminates the need for additional machining that allows the labyrinth clearance δ to be formed, enabling an increase in machining cost to be prevented.

The machining reference surface (area K1) has a predetermined length in the axial direction. For example, the area K1 (non-plated surface portion 21) has an axial length of, for example, 10 millimeters to 15 millimeters. The labyrinth clearance δ is formed between the area K1 (non-plated surface portion 21) and the facing portion 32 of the slinger 16. This enables an increase in the axial length of the labyrinth clearance δ, allowing enhancement of the function to suppress entrance of foreign matter.

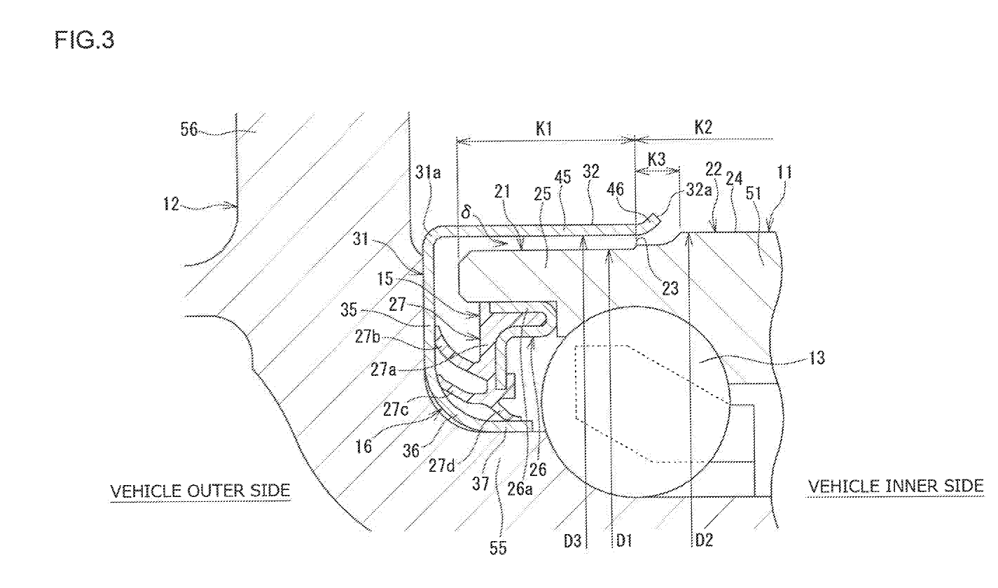

In the form depicted in FIG. 2, the vehicle-inner-side end 32a of the facing portion 32 is positioned outward of the boundary 23 between the non-plated surface portion 21 and the plated surface portion 22 in the radial direction. The facing portion 32 externally covers the entire non-plated surface portion 21 in the radial direction. FIG. 3 is a sectional view depicting a variation of the facing portion 32 of the slinger 16. In the form depicted in FIG. 3, the vehicle-inner-side end 32a of the facing portion 32 is positioned further on the vehicle inner side with respect to the boundary 23.

Specifically, the end 32a of the facing portion 32 extends beyond the boundary 23 toward the vehicle inner side and is positioned outward of the area K3 of the turned surface in the radial direction. The area K3 is turned. However, a plating layer remains in the area K3, which is thus included in the plated surface portion 22. The facing portion 32 depicted in FIG. 3 has a cylindrical main portion 45 and a tapered sub-portion 46. The main portion 45 is linear in the axial direction. The sub-portion 46 has a diameter increasing from the main portion 45 toward the vehicle inner side. The sub-portion 46 externally covers (at least) a part of the area K3 of the turned surface in the radial direction.

In the form depicted in FIG. 3, the facing portion 32 of the slinger 16 is configured so as to radially externally cover the non-plated surface portion 21 and a part of the plated surface portion 22, which is continuous with the non-plated surface portion 21. In this case, the entire non-plated surface portion 21 is externally covered by the facing portion 32 in the radial direction and thus hidden from the outside in the radial direction.

As described above, the bearing apparatus for wheels 10 in the above-described forms enables foreign matter such as water to be made less likely to enter the bearing interior without the use of an additional member on the vehicle outer side as in the related art. This prevents increases in component cost and man-hour needed to attach an additional component in order to enhance sealing performance on the vehicle outer side.

The embodiment disclosed above is illustrative in every way and is not restrictive. In other words, the bearing apparatus for wheels in the invention is not limited to the illustrated forms and may be in any other form within the scope of the invention. In the form depicted in FIG. 1, the rolling elements 13 are described as balls. However, the rolling elements 13 may be tapered rollers or the like. The seal 15 may have a shape other than the illustrated shape.

The bearing apparatus for wheels in the invention enables external foreign matter such as water to be made less likely to enter the bearing interior without the use of an additional member. This prevents increases in component cost and man-hour needed to attach an additional component in order to enhance the sealing performance on the vehicle outer side.

What is claimed is:

1. A bearing apparatus for wheels comprising:
an outer ring fixed to a vehicle-body-side member;
a hub shaft provided inward of the outer ring in a radial direction and having a flange portion for wheel attachment on a vehicle outer side;
rolling elements provided between the outer ring and the hub shaft;
a seal attached to a vehicle-outer-side part of the outer ring; and
a slinger that is attached to a vehicle-outer-side part of the hub shaft and contacted by the seal, wherein
an outer peripheral surface of the outer ring has a non-plated surface portion provided at a vehicle-outer-side end and a plated surface portion continuous with the non-plated surface portion, and
the slinger has a slinger main body portion that is contacted by the seal and a cylindrical facing portion that faces the non-plated surface portion to furan a labyrinth clearance.

2. The bearing apparatus for wheels according to claim 1, wherein the non-plated surface portion is a machined surface serving as a reference that allows the outer ring to be machined.

3. The bearing apparatus for wheels according to claim 1, wherein the facing portion radially externally covers the non-plated surface portion and a part of the plated surface portion, which is continuous with the non-plated surface portion.

4. The bearing apparatus fix wheels according to claim 2, wherein the facing portion radially externally covers the non-plated surface portion and a part of the plated surface portion, which is continuous with the non-plated surface portion.
